(19) United States
(12) Patent Application Publication
(10) Pub. No.: US 2013/0293009 A1
(43) Pub. Date: Nov. 7, 2013

(54) ENERGY MANAGEMENT DEVICE, ENERGY MANAGEMENT METHOD, AND AUDIO AND/OR VISUAL DEVICE

(71) Applicant: SONY CORPORATION, TOKYO (JP)

(72) Inventors: Yoichiro SAKO, Tokyo (JP); Itaru KAWAKAMI, Kanagawa (JP); Tatsuya INOKUCHI, Tokyo (JP); Kazutoshi SERITA, Tokyo (JP)

(73) Assignee: SONY CORPORATION, TOKYO (JP)

(21) Appl. No.: 13/852,102

(22) Filed: Mar. 28, 2013

(30) Foreign Application Priority Data
May 1, 2012 (JP) 2012104449

(51) Int. Cl. H02J 4/00

(52) U.S. Cl. CPC H02J 4/00
USPC 307/11

(57) ABSTRACT

There is provided an energy management device that sets a priority in a plurality of electric devices when power limitation is performed, receives a status signal from a predetermined electric device that is a priority changing target, and generates a control signal configured to change the priority of the predetermined electric device to be higher based on the status signal when the power limitation is performed.

### BACKGROUND

The present disclosure relates o an energy management device, an energy management method, and an audio and/or visual device applicable to, for example, household energy management.

Power consumption in households and the like continues to increase, and thus it is desirable to efficiently control balance between electric power supply and demand. Supply of system power is limited due to the restricted amount of power supply or it is necessary to further restrain power consumption due to the limitation of contracted power. When power failure occurs, the power failure can be temporarily avoided by providing a private electric generator or a power source such as a battery. However, since the amount of power supply of the private electric generator or the power source such as a battery is smaller than that of commercial power, power supply by the power source is known to be performed according to preset priority. For example, methods disclosed in Japanese Unexamined Patent Application Publication No. 2003-092844, Japanese Unexamined Patent Application Publication No. 2004-328960, and Japanese Unexamined Patent Application Publication No. H09-135541 have been suggested.

Japanese Unexamined Patent Application Publication No. 2003-092844 discloses a method of considering the duration of a power failure period when electric devices to which power is to be supplied by a private electric generator are selected at the time of power failure of commercial power. For example, when the power failure period is short, freezing and refrigeration devices are stopped. However, when the power failure period is long, the freezing and refrigeration devices are alternately paused or normally operated.

Japanese Unexamined Patent Application Publication No. 2004-328960 discloses a method of classifying electric devices into four groups in advance according to priority and restricting power supply in order from the electric devices with the lower priority in consideration of the remaining capacity of a battery when power is supplied from the battery to the electric devices at the time of power failure.

Japanese Unexamined Patent Application Publication No. H09-135541 discloses a method of enabling the priority of loads to be set in breakers and interrupting power supply to breakers other than the breakers with high priority and supplying the power to an uninterruptible power device for the remaining loads when a power failure occurs. Further, Japanese Unexamined Patent Application Publication No. H09-135541 discloses a method of changing the priority according to a period of time. For example, Japanese Unexamined Patent Application Publication No. H09-135541 discloses a method of setting the priority of electric lamps to be low during the daytime, while setting the priority of some of the electric lamps to be high when a power failure occurs during the nighttime.

### SUMMARY

In Japanese Unexamined Patent Application Publication No. 2003-092844, Japanese Unexamined Patent Application Publication No. 2004-328960, and Japanese Unexamined Patent Application Publication No. H09-135541 described above, the priority is preset in units of electric devices, and the power supply is limited from the electric device with low priority when the power is limited at the time of occurrence of power failure or the like. For example, in Japanese Unexamined Patent Application Publication No. 2003-092844, the power supply to an audio and/or visual device (hereinafter, appropriately referred to as an AV device) is normally stopped, irrespective of the duration of the power failure period. For example, in Japanese Unexamined Patent Application Publication No. 2004-328960, electronic locks or detectors can be exemplified as the electric devices with high priority. A ventilation system can be exemplified as the electric device with low priority.

However, when important interesting content is viewed while viewing an AV device such as a television receiver, necessity to perform power supply is considerably raised. For example, when content such as a match of user's nation in the World Cup of soccer or a World Cup final match is interrupted while viewing the match, users may undergo considerably stress. The same may also apply to baseball games (particularly, the Japan Series or the World Series), interesting events in the Olympic, tennis matches, major golf games, American football matches, professional basketball matches, or the like. Japanese Unexamined Patent Application Publication No. 2003-092844, Japanese Unexamined Patent Application Publication No. 2004-328960, and Japanese Unexamined Patent Application Publication No. H09-135541 described above disclose methods of setting the priority according to the kinds of electric devices. Accordingly, there is a problem that the power supply may not be limited in consideration of the details of the content.

It is desirable to provide an energy management device, an energy management method, and an audio and/or visual device capable of enabling power supply not to be limited when important content is watched.

According to an embodiment of the present disclosure, there is provided an energy management device that sets a priority in a plurality of electric devices when power limitation is performed, receives a status signal from a predetermined electric device that is a priority changing target, and generates a control signal configured to change the priority of the predetermined electric device to be higher based on the status signal when the power limitation is performed.

According to an embodiment of the present disclosure, there is provided an energy management method including setting a priority in a plurality of electric devices when power limitation is performed, receiving a status signal from a predetermined electric device that is a priority changing target, and changing the priority of the predetermined electric device to be higher based on the status signal when the power limitation is performed.

According to an embodiment of the present disclosure, there is provided an audio and/or visual device that is set to one of a power limitation target and a non-power limitation target by an energy management device, when power limitation is performed. The audio and/or visual device is set to the non-power limitation target when important content is being viewed or recorded.

According to the embodiments of the present disclosure, it is possible to prevent viewing or recording from being forcibly interrupted due to the power limitation performed while interesting and important content is viewed or recorded.

### BRIEF DESCRIPTION OF THE DRAWINGS

FIG. 1 is a block diagram illustrating a first embodiment of the present disclosure;

FIG. 2 is a flowchart for describing first control according to an embodiment of the present disclosure;

FIG. 3 is a flowchart for describing second control according to an embodiment of the present disclosure;

FIG. 4 is a flowchart for describing third control according to an embodiment of the present disclosure; and

FIG. 5 is a block diagram illustrating a second embodiment of the present disclosure.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Embodiments to be described below are specific preferred embodiments of the present disclosure and include various technically preferred limitations. However, the scope of the embodiments of the present disclosure is not limited to the embodiments, unless specifically indicated otherwise. The description will be made in the following order.

### <1. First Embodiment>

### <2. Second Embodiment>

### <3. Modification Examples>

### 1. First Embodiment

### System Configuration

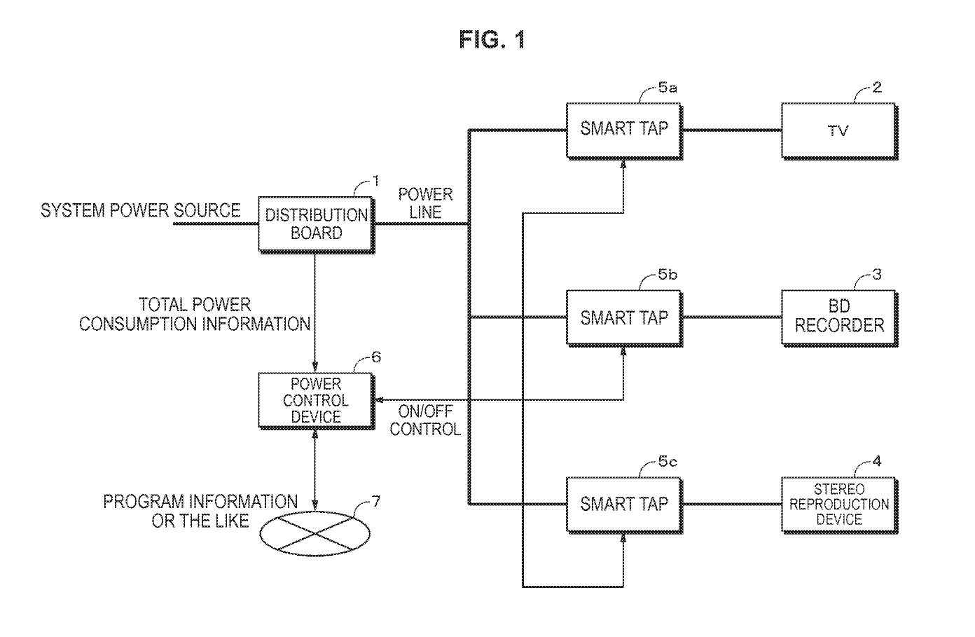

An example of a power system such as a household power system to which an embodiment of the present disclosure can be applied will be described with reference to FIG. 1. A power line is introduced from an outdoor distribution line to a building via a leading wire. The power line is connected to a power meter (not shown). A distribution board 1 is connected to the output side of the power meter. A plurality of electric devices are connected from the distribution board 1 to indoor distribution lines. In FIG. 1, as AV devices among the electric devices, for example, a television receiver (written as “TV” in the drawing) 2, a Blu-ray disc (BD) recorder 3, and a stereo reproduction device 4 are shown.

In Japan, the distribution board 1 includes a service breaker, an electric-leakage breaker, and a safety breaker from the leading side. The service breaker is a breaker that automatically blocks electricity when an incoming current is equal to or greater than a current contracted with a power company. The electric-leakage breaker is a breaker that detects electric leakage of an indoor distribution line or an electric device and automatically blocks electricity. The safety breaker is mounted on a branching circuit that sends electricity from the distribution board 1 to each room. The safety breaker is a breaker that automatically blocks electricity when a short-circuit occurs due to breakdown of an electric device or a distribution line and an overcurrent flows.

The distribution board 1 is connected to the television receiver 2, the Blu-ray disc (BD) recorder 3, and the stereo reproduction device 4 by power lines. Further, smart taps 5a, 5b, and 5c (simply referred to as the smart taps 5, when it is not particularly necessary to distinguish the smart taps 5a, 5b, and 5c from each other) are connected as electric outlets to which the electric devices are connected. Identification information on each device is added to data transmitted by the smart taps 5. Further, the smart taps 5 are configured to turn on/off the power of the electric devices connected thereto.

The smart taps 5 and the power control device 6 are connected to perform bi-directional communication via communication lines. A home network may be used as the communication lines. The power control device 6 is specifically a home gateway (home server), since the power control device 6 controls power limitation. The power control device 6 can be connected to a network such as the Internet 7, and thus can acquire various kinds of information such as television program information from the Internet 7.

Power supply information on planned power saving, power failure, or the like from a power providing company can be also acquired from the Internet 7. Information on contracted power and total power consumption information of a household is supplied from the distribution board 1 to the power control device 6. When an available battery or a private power generator is equipped as an uninterruptible power device in the household, information on the remaining capacity is supplied to the power control device 6. The power control device 6 is configured to control the degree of power saving or the like from the information on the remaining capacity.

The acquired information is stored in a storage unit of the power control device 6. The power control device 6 includes a CPU that performs various calculation and control processes, a storage unit (a ROM, a RAM, or the like) that stores a database, a program, or the like, and an input/output interface that performs input and output control of information between the power control device 6 and the outside. An input of a user's operation is supplied to the CPU via the input/output interface and necessary information is supplied and displayed on a display device. The power control device 6 can control ON/OFF of power supply to a desired electric device by performing communication with the smart taps 5.

In the power control device 6, the priority used in the power limitation at the time of the power limitation is determined in advance. The power limitation includes interruption (OFF) of the power supply and intermittent power supply. A case in which the power supply is ON but an operation mode of an electric device is an energy saving mode is one form of the power limitation. In the case of the television receiver 2, the power consumption can be decreased by darkening a screen. The normal priority is set according to the level of importance of the power supply. For example, the priority of a device such as an electronic lock relevant to security is considered to be high. The priority of a ventilation system, air-conditioning system, an AV device, and the like are considered to be low.

In the power control device 6, predetermined target electric devices in which the priority is normally changed are set in advance. According to the embodiment of the present disclosure, the television receiver 2, the BD recorder 3, and the stereo reproduction device 4 of the AV devices are set as the priority changing target electric devices.

The power control device 6 receives status signals from the priority changing target electric devices. That is, the power control device receives signals indicating operation status of the priority changing target electric devices. For example, when the priority changing target electric device is the television receiver 2, the power control device receives a signal indicating whether a broadcast program is being viewed. When the priority changing target electric device is the BD recorder 3, the power control device receives a signal indicating whether data is being recorded.

The power control device 6 determines whether it is necessary to change the priority at the time of the power limitation using the received status signal. For example, when the power limitation is controlled and important content is being viewed on the television receiver 2, the power limitation on the television receiver 2 is not performed. Thus, it is possible to prevent the important content from being abruptly interrupted due to the change in the priority while the important content is being viewed.

### First Control Example

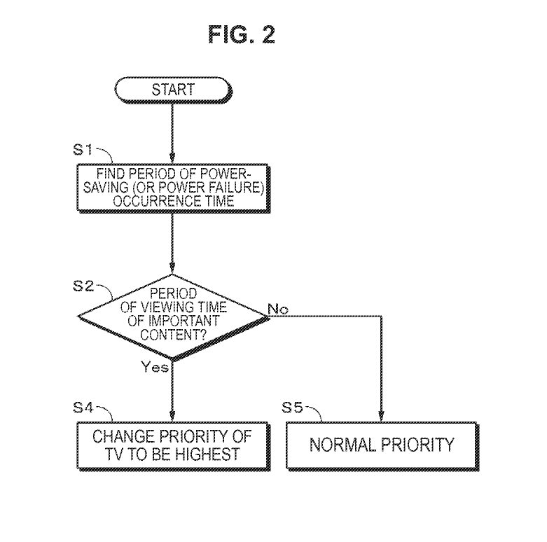

A first control example according to the first embodiment of the present disclosure will be described with reference to the flowchart of FIG. 2. This control is performed under the control of the power control device 6. In step S1, a period of power-saving (or power failure) occurrence time is found. Information on this period of time can be obtained from the Internet 7 when a power providing company performs planned power-saving (or power failure). As another method, when the total power consumption information from the distribution board 1 reaches the contracted power, it is detected that there is a probability of a power failure. The period of power-saving (or power failure) occurrence time can be found according to still another method.

In step S2, it is determined whether the period of power-saving or power failure occurrence time overlaps a period of viewing time of important content. The important content is content for which interruption due to power failure or power-saving while the important content is being viewed is not desired. The period of viewing time of important content can be defined by a user. For example, the user can set any period of viewing time of important content by operating an operation unit relevant to the power control device 6. For example, when the user is viewing a given program, the user can previously designate the program as important content.

As another method, the period of viewing time of important content can be set using program information acquired from the Internet 7. As still another method, the power control device 6 may set user-related information such as user preference information, a user profile, a keyword, or the like in advance. When information included in the program information is identical with the user-related information, the important content may be determined and the period of broadcast time of the program may be understood as the period of viewing time of important content.

In step S3, when it is determined that the period of power-saving or power failure occurrence time does not overlap the period of viewing time of important content as the determination result of step S2, the power limitation is performed according to the normal priority. The normal priority is set in advance in the power control device 6. That is, electric devices relevant to safety such as security systems or fire-safety and disaster prevention systems are considered to have the highest priority. Next, a freezer and a refrigerator are considered as electric devices that have high priority and are preferably supplied with power whenever possible to prevent corruption of storage. A ventilation system and AV devices normally belong to a group having low priority. Accordingly, according to the normal priority, power supply to AV devices is initially limited. When important content is not being viewed, it can be said that there is little dissatisfaction with the power limitation.

In step S4, when it is determined that the period of power-saving or power failure occurrence time overlaps the period of viewing time of important content as the determination result of step S2, the television receiver 2 is considered to have the highest priority. That is, when important content is being viewed, the power limitation is not performed, and thus the important content can be prevented from being interrupted. Thus, there is no dissatisfaction. Further, at the closing timing of the period of viewing time of important content, the change in the priority may be cancelled and the normal priority may be restored. Further, when the priority of the television receiver 2 is set to be high, the priority of the other electric devices can be lowered, and thus the power limitation is performed on the other electric devices. That is, the power limitation is performed such that the total power consumption is the same as that when the power of the television receiver 2 is limited. For example, the power of a refrigerator is limited instead of the television receiver 2.

### Second Control Example

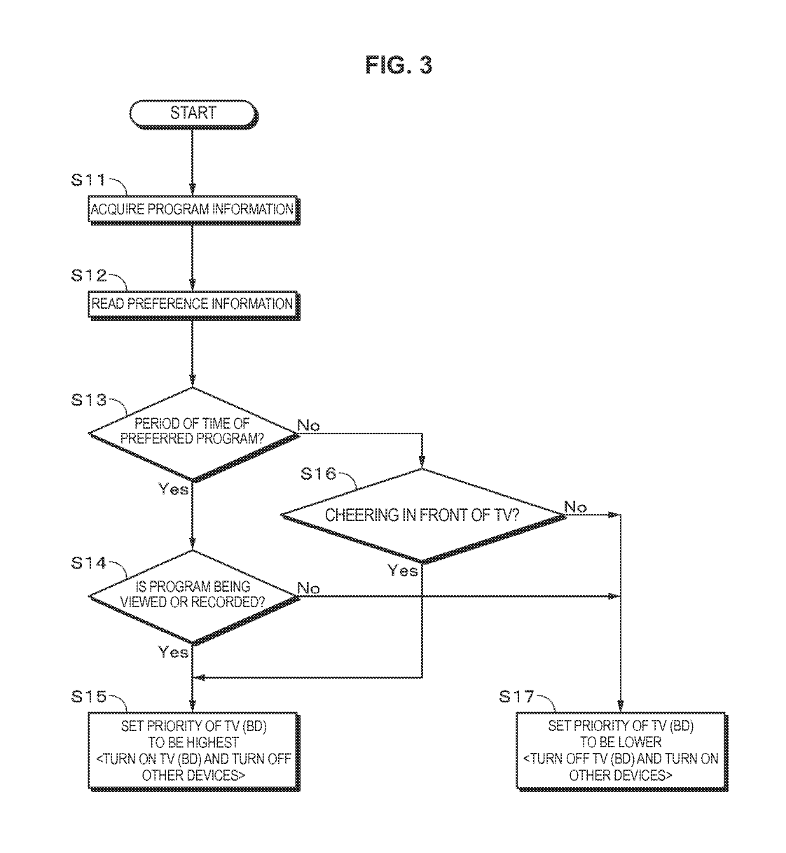

A second control example according to the first embodiment of the present disclosure will be described with reference to FIG. 3. This control is performed under the control of the power control device 6.

In this example, a microphone that detects whether cheering is taking place in front of the television receiver 2 and a signal processing unit that processes a sound correction signal of the microphone are provided. An output of the signal processing unit is transmitted to the power control device 6. Further, status information indicating whether the BD recorder 3 is recording a program being viewed is transmitted to the power control device 6.

In step S11, program information on television broadcast is acquired. The program information may be acquired via the Internet 7 or may be acquired from an electronic program table included in the television broadcast.

In step S12, the user preference information stored in the power control device 6 is read. For example, the user preference information is considered to be identical with information (a genre, a performer, a keyword, or the like) included in the program information and a program matching the user preference information is retrieved.

In step S13, it is determined according to the retrieval whether the current time is a period of time of a preferred program. In step S14, it is determined whether the preferred program is being viewed in the television receiver 2 or is being recorded by the BD recorder 3.

In step S15, when it is determined in step S14 that the program is being viewed, the priority of the television receiver 2 or the BD recorder 3 is considered to be the highest. That is, when the power limitation is performed, the television receiver 2 is considered to be turned on, and thus the power of the television receiver 2 is not limited. Further, when it is determined in step S14 that the program is being recorded and the power limitation is performed, the BD recorder 3 is considered to be turned on, and thus the power of the BD recorder 3 is not limited. Thus, the viewing or recording of the program matching the user preference information can be prevented from being forcibly terminated as the result of the power limitation. Further, at the closing timing of the program matching the user preference information, the change in the priority may be cancelled and the normal priority may be restored. Further, as described above, when the priority is changed to be higher, the priority of the other electric devices can be lowered, and thus the power limitation is performed on the other electric devices.

In step S16, when it is determined in step S13 that the current time is not the period of time of the preferred program, it is determined whether cheering is taking place in the front of the television receiver 2. When it is determined that cheering is taking place, the process proceeds to step S15. That is, as described above, the priority of the television receiver 2 (during the viewing) is considered to be the highest. Thus, when cheering is actually taking place even in a program not matching the user preference information, the viewing of the program can be prevented from being forcibly terminated due to the power limitation. In the second control example, when a user other than the user for whom the preference information is registered views a program, effective handling can be possible, for example, when video software is reproduced by the BD recorder 3.

In step S17, when the determination result of step S14 is negative, that is, it is determined that the program is being viewed or recorded, the process proceeds to step S17. Further, when the determination result of step S16 is negative, that is, it is determined that no cheering is taking place in the front of the television receiver 2, the process proceeds to step S17. In step S17, the priority of the television receiver 2 and the priority of the BD recorder 3 are considered to be low. Accordingly, when the power limitation is performed, the television receiver 2 and the BD recorder 3 are considered to be turned off preferentially before other devices.

In the above-described example, it is determined in step S16 whether cheering is taking place in the front of the television receiver 2. When it is determined that cheering is taking place, it is determined that the important content is being viewed. In this case, an imaging device that images viewers or a sensor that detects people may be mounted on the television receiver 2 and the number of users viewing a program may be detected based on a captured image. For example, when a number of users equal to or greater than 3 is detected in the front of the television receiver 2, it is determined that there is a high possibility that the users are enjoying their program, and thus it is determined that the important content is being viewed.

### Third Control Example

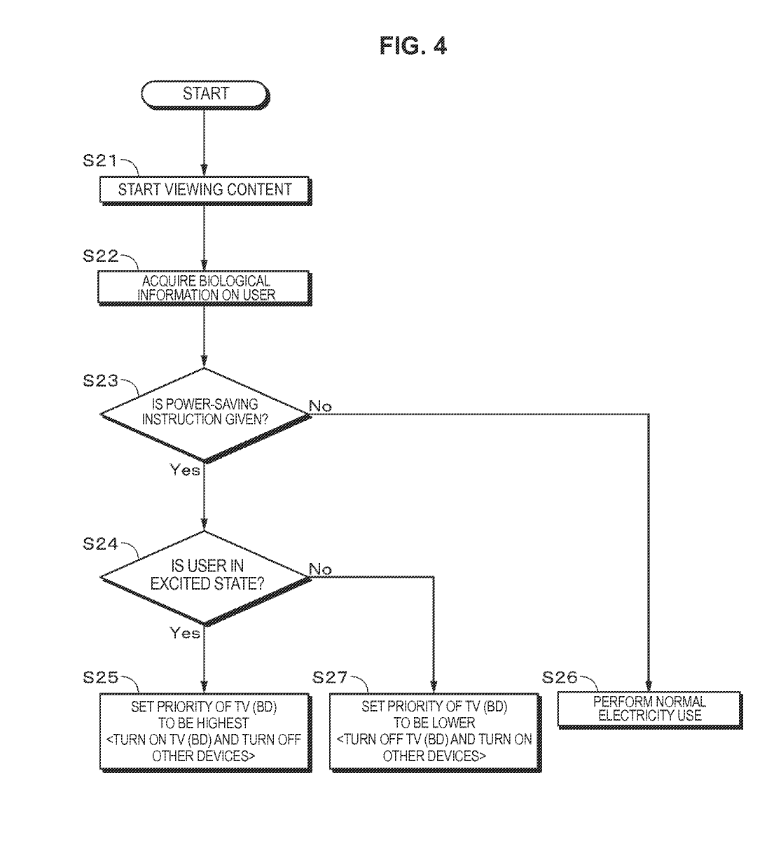

A third control example according to the first embodiment of the present disclosure will be described with reference to FIG. 4. This control s performed under the control of the power control device 6.

In this example, it is necessary to provide a sensor that acquires biological information on a user who is viewing the television receiver 2. Examples of the biological information include a pulse and perspiration. The biological information acquired by the sensor is transmitted to the power control device 6 by, for example, wireless communication.

In step S21, the user starts viewing content with the television receiver 2. The content is not limited to a television broadcast program, but also includes content such as video software reproduced by the BD recorder 3.

In step S22, the biological information on the user is acquired.

In step S23, it is determined whether a power-saving instruction is given. The power-saving instruction may be a power-saving instruction given from the outside such as a power providing company or a power-saving instruction from a household (or a community of a plurality of households) unit.

In step S24, when it is determined in step S23 that the power-saving instruction is given, it is determined whether the user is in an excited state based on the biological information. When the pulse rate increases or the amount of perspiration increases, it can be determined that the user is in the excited state. The biological information used for the determination preferably includes a plurality of kinds of information.

In step S25, when it is determined in step S24 that the user is in the excited state, the priority of the television receiver 2 is considered to be the highest. When video content reproduced by the BD recorder 3 is being viewed, the priority of the television receiver 2 and/or the priority of the BD recorder 3 is considered to be the highest. That is, when the power limitation is performed, the television receiver 2 (the BD recorder 3) is considered to be turned on, and thus the power of the television receiver 2 is not limited. Thus, when it is detected that the user is in the excited state in which the user is viewing the content, the viewing of the content can be prevented from being forcibly terminated as the result of the power limitation. Since the control can be performed based on the actual excited state of the user, the appropriate control can be realized. Further, when a period in which the user is not in the excited state continues for a period equal to or greater than a predetermined period, the change in the priority may be canceled and the normal priority may be restored. As described above, when the priority is changed to be higher, the priority of the other electric devices can be lowered, and thus the power limitation on the other electric devices is performed.

In step S26, when it is determined in step S23 that the power-saving instruction is not given, normal electricity use is performed.

In step S27, when it is determined in step S24 that the user is not in the excited state, the priority is not changed. That is, the priority of the television receiver 2 (the BD recorder 3) is considered to be low. Accordingly, when the power limitation is performed, the television receiver 2 and the BD recorder 3 are considered to be turned off preferentially before other devices.

### 2. Second Embodiment

### System Configuration

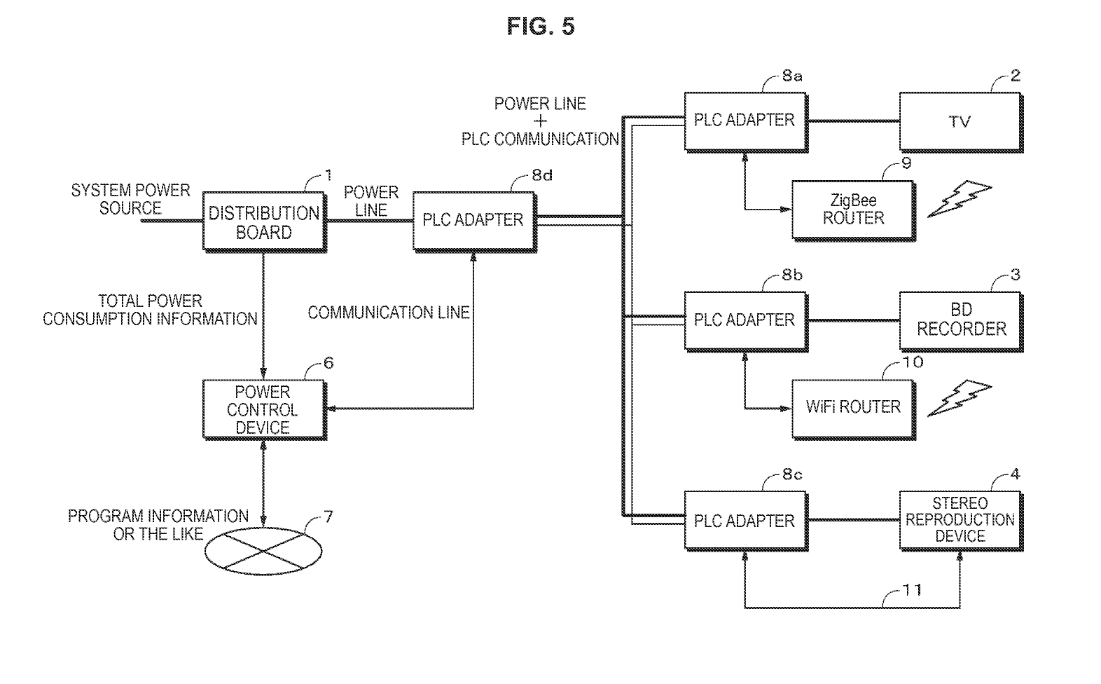

A second embodiment of the present disclosure will be described with reference to FIG. 5. The same reference numerals are given to the portions corresponding to those of the first embodiment (FIG. 1). A plurality of electric devices are connected from the distribution board 1 to indoor distribution lines. As AV devices, for example, a television receiver (written as “TV” in the drawing) 2, a Blu-ray disc (BD) recorder 3, and a stereo reproduction device 4 among the electric devices are shown in the drawing.

The distribution board 1 is connected to the television receiver 2, the Blu-ray disc (BD) recorder 3, and the stereo reproduction device 4 by power lines. Further, a power line is used as a bi-directional communication line. Such a technique is called power line communication (PLC). PLC adapters (PLC modems) 8a, 8b, and 8c (simply referred to as the PLC adapters 8, when it is not particularly necessary to distinguish the PLC adapters 8a, 8b, and 8c from each other) for communication are connected as electric outlets to which the electric devices are connected. The power lines are used to supply power and perform PLC communication. Therefore, a PLC adapter 8d is installed, and the PLC adapter 8d and the power control device 6 are connected to each other by a communication line. For example, a smart tap is used and identification information on each device is added to data to be transmitted by the PLC adapter 8. Even when a smart tap is not used, each device may generate identification information on the device itself and the identification information may be transmitted by the PLC.

In the second embodiment, a communication unit is provided in association with each of the PLC adapters 8 of the television receiver 2, the BD recorder 3, and the stereo reproduction device 4. That is, a ZigBee router 9 is provided in association with the PLC adapter 8a of the television receiver 2. A WiFi router 10 is provided in association with the BD recorder 3. A wired LAN 11 is provided in association with the stereo reproduction device 4. Such schemes of the communication units are merely examples and other communication schemes may be used.

The ZigBee router 9 performs bi-directional communication with the television receiver 2. The ZigBee router wirelessly receives information on an operation status of the television receiver 2, and then transmits the information on the operation status to the power control device 6 via the power line and the PLC adapter 8a. Further, the ZigBee router receives a control signal (for example, a remote control signal) generated to control the television receiver 2 by the power control device 6 via the power line and the PLC adapter 8a, and then wirelessly transmits the control signal to the television receiver 2.

The WiFi router 10 performs bi-directional communication with the BD recorder 3. The WiFi router wirelessly receives information on an operation status of the BD recorder 3, and then transmits the information on the operation status to the power control device 6 via the power line and the PLC adapter 8b. Further, the WiFi router receives a control signal (for example, a remote control signal) generated to control the BD recorder 3 by the power control device 6 via the power line and the PLC adapter 8b, and then wirelessly transmits the control signal to the BD recorder 3.

The wired LAN 11 performs bi-directional communication with the stereo reproduction device 4. The wired LAN receives information on an operation status of the stereo reproduction device 4 and transmits the information on the operation status to the power control device 6 via the power line and the PLC adapter 8c. Further, the wired LAN receives a control signal (for example, a remote control signal) generated to control the stereo reproduction device 4 by the power control device 6 via the power line and the PLC adapter 8c, and then transmits the control signal to the stereo reproduction device 4.

In the above-described second embodiment, the power control device 6 can receive the information on the status of each device and transmit the control signal for each device. Accordingly, more complex control than in the first embodiment can be performed. For example, rather than simple ON/OFF of the power, the supply of the power can be in the ON state but the power limitation can be performed with an operation mode of the electric device set as an energy-saving mode. For example, in the case of the television receiver 2, the power consumption can be decreased by darkening a screen.

In the above-described second embodiment, a wired communication scheme or a wireless communication scheme other than the PLC can be used. When a wireless communication scheme is used, a network can be used in conformity with a wireless communication scheme such as a wired local area network (LAN), Bluetooth (registered trademark), or ZigBee. In Bluetooth (registered trademark), one-to-multiple connection communication can be performed by applying multimedia communication. In ZigBee, the physical layer of Institute of Electrical and Electronics Engineers (IEEE) 802.15.4 is used. IEEE 802.15.4 is the name of a short-range wireless network standard known as a personal area network (PAN) or wireless (W) PAN.

The Digital Living Network Alliance (DLNA) may be used as a connection scheme of the audio and/or video (AV) devices. The DLNA is an industrial organization established to formulate specifications in which digital AV devices or personal computers are connected by a home network and data such as moving images, music, or still images is mutually used.

### 3. Modification Examples

The embodiments of the present disclosure have been described specifically. However, embodiments of the present disclosure are not limited to the above-described embodiment, but may be modified in various ways based on the technical sprit and essence of the present disclosure. For example, the configurations, the methods, the processes, the shapes, the materials, the numerical values, and the like mentioned in the above-described embodiments are merely examples. Different configurations, methods, processes, shapes, materials, numerical values, and the like may be used, as necessary.

For example, in the embodiments of the present disclosure, an eruptible power device (a battery, a private electric generator, or the like) may be provided. When the power limitation is performed, power is supplied to the electric devices by the uninterruptible power device. Further, when the priority changing target electric devices are set, the same kinds of electric devices may or may not be set. In the case of a television receiver, for example, only a television receiver with the maximum screen size may be set as the target among a plurality of television receivers in a home. Furthermore, in the above-described control examples, when the television receiver and the BD recorder are set as the priority changing target devices, the stereo reproduction device may also be set as a priority changing target device. For example, the stereo reproduction device is not turned off during reproduction of an audio recording medium but is turned off after the reproduction ends.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An energy management device that sets a priority in a plurality of electric devices when power limitation is performed, receives a status signal from a predetermined electric device that is a priority changing target, and generates a control signal configured to change the priority of the predetermined electric device to be higher based on the status signal when the power limitation is performed.
(2) The energy management device according to (1), wherein the predetermined electric device is a device with which an audio and/or visual content is being viewed or recorded.
(3) The energy management device according to (1), wherein the status signal is a signal indicating whether important content is being viewed or recorded by the predetermined electric device.
(4) The energy management device according to (3), wherein the energy management device stores user preference information and defines the important content based on the user preference information.
(5) The energy management device according to (4), wherein the predetermined electric device is a broadcast reception device and the important content is defined based on program information of the broadcast reception device and the user preference information.
(6) The energy management device according to (1), wherein a signal indicating an excited state of a user is received from the predetermined electric device, and it is determined that the user is viewing the important content when the user is in the excited state.
(7) The energy management device according to (5), wherein a signal indicating an excited state of a user is a biological information signal of the user.
(8) The energy management device according to (1), wherein a period of time in which the priority of the predetermined electric device is changed to be higher is defined.
(9) An energy management method including:

setting a priority in a plurality of electric devices when power imitation is performed;

receiving a status signal from a predetermined electric device that is a priority changing target; and

changing the priority of the predetermined electric device to be higher based on the status signal when the power limitation is performed.

(10) An audio and/or visual device that is set to one of a power limitation target and a non-power limitation target by an energy management device, when power limitation is performed,

wherein the audio and/or visual device is set to the non-power limitation target when important content is being viewed or recorded.

The present disclosure contains subject matter related to that disclosed in Japanese Priority Patent Application JP 2012-104449 filed in the Japan Patent Office on May 1, 2012, the entire content of which is hereby incorporated by reference.

What is claimed is:

1. An energy management device that sets a priority in a plurality of electric devices when power limitation is performed, receives a status signal from a predetermined electric device that is a priority changing target, and generates a control signal configured to change the priority of the predetermined electric device to be higher based on the status signal when the power limitation is performed.

2. The energy management device according to claim 1, wherein the predetermined electric device is a device with which an audio and/or visual content is being viewed or recorded.

3. The energy management device according to claim 1, wherein the status signal is a signal indicating whether important content is being viewed or recorded by the predetermined electric device.

4. The energy management device according claim 3, wherein the energy management device stores user preference information and defines the important content based on the user preference information.

5. The energy management device according to claim 4, wherein the predetermined electric device is a broadcast reception device and the important content is defined based on program information of the broadcast reception device and the user preference information.

6. The energy management device according to claim 1, wherein a signal indicating an excited state of a user is received from the predetermined electric device, and it is determined that the user is viewing the important content when the user is in the excited state.

7. The energy management device according to claim 5, wherein a signal indicating an excited state of a user is a biological information signal of the user.

8. The energy management device according to claim 1, wherein a period of time in which the priority of the predetermined electric device is changed to be higher is defined.

9. An energy management method comprising:
setting a priority in a plurality of electric devices when power limitation is performed;
receiving a status sig al from a predetermined electric device that is a priority changing target; and
changing the priority of the predetermined electric device to be higher based on the status signal when the power limitation is performed.

10. An audio and/or visual device that is set o one of a power limitation target and a non-power limitation target by an energy management device, when power limitation is performed,
wherein the audio and/or visual device is set to the non-power limitation target when important content is being viewed or recorded.
